(19) United States
(12) Patent Application Publication
(10) Pub. No.: US 2026/0300184 A1
(43) Pub. Date: Oct. 1, 2026

(54) DATA STORAGE DEVICE FOR MANAGING MAPPING INFORMATION, METHOD OF OPERATING THE SAME AND MEMORY CONTROLLER FOR THE SAME

(71) Applicant: SK hynix Inc., Gyeonggi-do (KR)

(72) Inventor: Sung Jin PARK, Gyeonggi-do (KR)

(21) Appl. No.: 19/296,950

(22) Filed: Aug. 12, 2025

(30) Foreign Application Priority Data
Mar. 26, 2025 (KR) 10-2025-0038700

(51) Int. Cl. G06F 12/1009

(52) U.S. Cl. CPC G06F 12/1009

(57) ABSTRACT

A data storage device may include a storage medium and a memory controller configured to control the storage medium. The memory controller may create a physical-logical address table (P2LT) with mapping information between a physical address of the storage medium and a logical address provided from an external device, read an update target logical-physical address (L2P) segment from a logical-physical address table (L2PT) stored on the storage medium based on the P2LT, store an update target L2P entry from the update target L2P segment in a map update buffer, and update the physical address of the update target L2P entry whenever the update target L2P entry is stored in the map update buffer.

### CROSS-REFERENCE TO RELATED APPLICATIONS

The present application claims priority under 35 U.S.C. § 119(a) to Korean patent application number 10-2025-0038700, filed on Mar. 26, 2025, which is incorporated herein by reference in its entirety.

### BACKGROUND

### 1. Technical Field

Example embodiments relate to a semiconductor integrated device, and more particularly to a data storage device for managing mapping information, a method of operating the same, and a memory controller for the same.

### 2. Related Art

A data storage device may process requests from external devices using non-volatile memory devices as storage media.

In instances in which a logical addressing system used by the external devices and a physical addressing system used by the storage media are different, the data storage device may manage a relationship between the logical and physical addresses with a mapping table.

The storage media such as flash memory devices may be difficult to update in place, so if the external device updates already stored data, the mapping information may change, and the mapping table may reflect the changed mapping information.

To change the mapping information, the data storage device may search for a map segment to be changed from the mapping table. The map segment may then be loaded into a memory device. An entry to be changed in the loaded map segment may be accessed and updated. The updated map segment may then be stored in the mapping table.

As a capacity of the storage medium may increase, so does a size of the mapping table, so an overhead of the changing mapping information by search for map segments and entries to change may degrade service performance to external devices.

### SUMMARY

According to embodiments of the present disclosure, a data storage device is provided. The data storage device may include a storage medium and a memory controller configured to control the storage medium. The memory controller may create a physical-logical address table (P2LT) with mapping information between a physical address of the storage medium and a logical address provided from an external device, read an update target logical-physical address (L2P) segment from a logical-physical address table (L2PT) stored on the storage medium based on the P2LT, store an update target L2P entry from the update target L2P segment in a map update buffer, and update the physical address of the update target L2P entry whenever the update target L2P entry is stored in the map update buffer.

According to example embodiments, there may be provided a method of operating a data storage device including a storage medium and a memory controller. In the method, the memory controller may generate mapping information between a physical address of the storage medium and a logical address provided from an external device as a physical-logical address table (P2LT). The memory controller may read an update target logical-physical address (L2P) segment from a logical-physical address table (L2PT) stored in the storage medium. The memory controller may store an update target L2P entry from the L2P segment in a map update buffer, wherein the update target L2P entry comprises at least one L2P entry to be updated. The memory controller may update the physical address of the update target L2P entry each time the update target L2P entry is stored in the map update buffer.

According to example embodiments, there may be provided a memory controller. The memory controller may include a search circuit and an update circuit. The search circuit may, when a map update event is triggered, configured to search for at least one update target logical-to-physical address (L2P) entry from a storage medium and store the at least one update target L2P entry in a map update buffer. The update circuit may allocate a portion of an internal memory to the map update buffer when the map update event is triggered, and update the at least one update target L2P entry stored in the map update buffer on an entry-by-entry basis.

### BRIEF DESCRIPTION OF THE DRAWINGS

The above and another aspects, features and advantages of the subject matter of the present disclosure will be more easily understood from the following detailed description taken in conjunction with the accompanying drawings, in which:

FIG. 1 is a diagram illustrating a data processing system according to an embodiment of the present disclosure;

FIG. 2 is a diagram illustrating a memory controller according to an embodiment of the present disclosure;

FIG. 3 is a diagram illustrating a physical-logical address table according to an embodiment of the present disclosure;

FIG. 4 is a diagram illustrating a logical-physical address table according to an embodiment of the present disclosure;

FIGS. 5A and 5B are views illustrating a concept for updating a logical-physical address table according to an embodiment of the present disclosure;

FIG. 6 is a view illustrating a method of operation of a data storage device according to an embodiment of the present disclosure; and

FIG. 7 is a view illustrating a concept for search for and updating logical-physical address entries according to an embodiment of the present disclosure.

### DETAILED DESCRIPTION

Reference will now be made in detail to the embodiments of the present disclosure, examples of which are illustrated in the accompanying drawings. Wherever possible, the same reference numbers will be used throughout the drawings to refer to the same or like parts. While the present disclosure is susceptible to various modifications and alternative forms, specific embodiments thereof are shown by way of example in the drawings. However, the present disclosure should not be construed as being limited to the embodiments set forth herein.

Hereinafter, various embodiments will be described with reference to the accompanying drawings. However, it should be understood that the present disclosure is not limited to specific embodiments, but includes various modifications, equivalents and/or alternatives of the embodiments. The embodiments of the present disclosure may provide a variety of effects capable of being directly or indirectly recognized through the present disclosure.

Embodiments of the present technology will now be described in more detail with reference to the accompanying drawings.

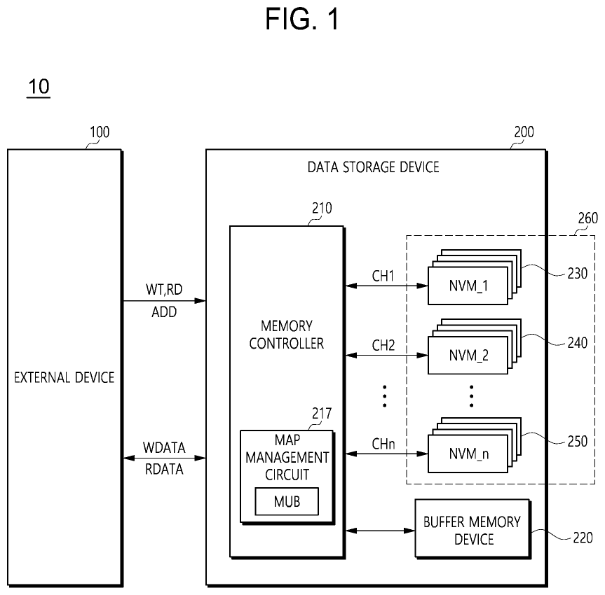

FIG. 1 is a diagram illustrating a data processing system 10 according to an embodiment of the present disclosure.

Referring to FIG. 1, the data processing system 10 may include an external device 100 and a data storage device 200.

The external device 100 may include at least one processor. The external device 100 may be a processor itself, or an electronic device or system including a processor. The external device 100 may be operated as an external device to the data storage device 200.

The data storage device 200 may include a memory controller 210 including a map management circuit 217, a buffer memory device 220 and a storage medium 260. The storage medium 260 may include at least a plurality of non-volatile memory devices (NVM_1 (230), NVM_2 (240), . . . , NVM_n (250)) electrically coupled to the memory controller 210 via at least one channel (CH1, CH2, . . . , CHn).

The external device 100 may send a write request including a write command WT, an address ADD, and write data WDATA to the data storage device 200 to record the data. In response, the data storage device 200 may control the storage medium 260 to program the write data WDATA.

The external device 100 may send a read request including a read command RD and an address ADD to the data storage device 200 to read the data. The data storage device 200 may read the read requested data RDATA from the storage medium 260 or the buffer memory device 220. The data storage device 200 may then send the read requested data RDATA to the external device 100.

The data storage device 200 may internally generate a read command or a write command to read or write data from the storage medium 260 to perform internal management operations for managing the storage medium 260. The internal management operations may include wear-leveling operations, garbage collection operations, read operations, and various other housekeeping operations performed independently of requests from the external device 100 to efficiently use storage space on the storage medium 260 or to ensure the reliability of data stored on the storage medium 260.

In example embodiments, the storage medium 260 may include a NAND flash memory device, a NOR flash memory device, a ferroelectric random access memory (RAM) (FRAM), a magnetic RAM (MRAM) using a tunneling magneto-resistive (TMR) layer, a phase change (random access) memory device (PRAM) using chalcogenide alloys, a resistive (random access) memory device (ReRAM) using transition metal oxide, and the like. The storage medium 260 may include at least one of various types of non-volatile memory devices 230, 240, and 250.

Each of the non-volatile memory devices 230, 240, and 250 may include a plurality of memory cells. Each of the memory cells may be operated as a single level cell (SLC) capable of storing one bit of data, or as a multi-level cell (MLC) capable of storing two or more bits of data. Some of the non-volatile memory devices 230, 240 and 250 may be configured to be operated as single level cell (SLC) memory devices and some as multi-level cell (MLC) memory devices. Some memory cells of each of the non-volatile memory devices 230, 240, and 250 may be operated as the single level cells (SLC) and other memory cells may be operated as the multi-level cells (MLC).

The map management circuit 217 may manage map data representing mapping relationships between logical addresses corresponding to data transmitted from the external device 100 and physical addresses in the storage medium 260. The map data may include a plurality of P2L segments, which may be sets of physical-to-logical address (P2L) entries, and a plurality of L2P segments, which may be sets of logical-to-physical address (L2P) entries.

The P2L entry may be mapping information between a logical address included in a write request received from the external device 100 and a physical address of the storage medium 260 where the write data associated with the write request may be stored, which may be a quasi-aligned mapping information.

The L2P entry may be mapping information between a logical address included in a write request received from the external device 100 and a physical address of the storage medium 260 where the write data associated with the write request may be stored, the mapping information being sorted by logical address.

When the map management circuit 217 receives the write request including the logical address and the write data from the external device 100, the map management circuit 217 may map the received logical address onto the physical address of the storage medium 260 where the write data is to be stored. The map management circuit 217 may store a P2L segment including a plurality of P2L entries that may be (or may include) the mapping information between the physical address and the logical address.

The map management circuit 217 may update the L2P segments stored on the storage medium 260 based on the updated P2L segments.

In particular, the map management circuit 217 may process, in parallel and independently, an operation that searches for at least one L2P entry to be updated and stores the L2P entry in the map update buffer (MUB) in turn when a map update event may be triggered, and an operation that allocates at least a portion of an internal memory of the map management circuit 217 to the map update buffer (MUB) and updates the at least one L2P entry to be updated stored in the map update buffer (MUB) on an entry-by-entry basis.

That is, while the first entry to be updated in the L2P segment to be updated may be (for example, in the process of being) searched and updated in the map update buffer MUB, the map management circuit 217 may search for a second entry to be updated in the L2P segment to be updated and store the second entry in the map update buffer MUB.

The operations for searching for entries in the L2P segment to be updated and updating the entries to be updated may be processed in parallel to improve map update performance.

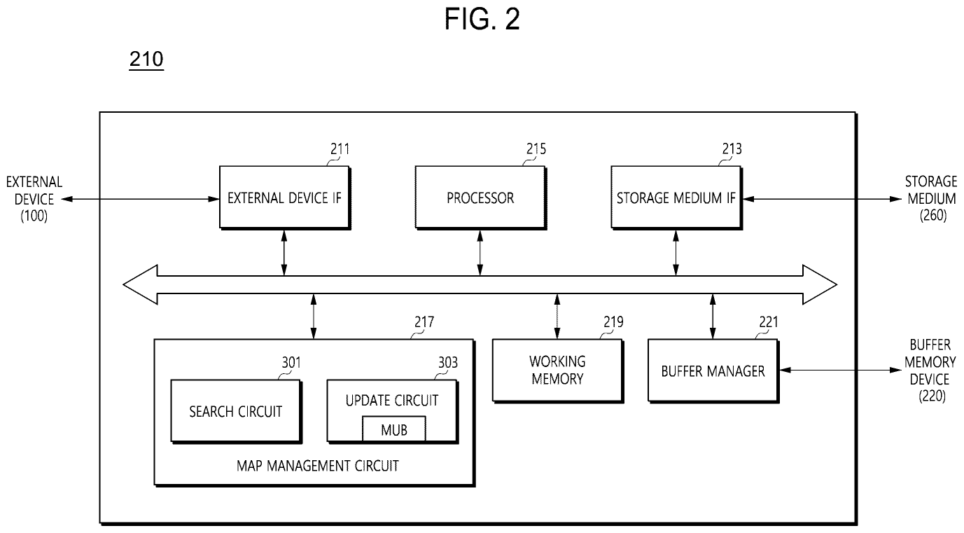

FIG. 2 is a diagram illustrating a memory controller 210 in accordance with embodiments of the present disclosure.

Referring to FIG. 2, the memory controller 210 may include an external device interface (IF) 211, a storage medium (or media) interface (IF) 213, a processor 215, a map management circuit 217, a working memory 219 and a buffer manager 221.

The external device IF 211 may provide a communication channel for receiving commands and clock signals from the external device 100 and controlling an input/output of data under the control of the processor 215. In particular, the external device IF 211 may provide a physical connection between the external device 100 and the storage medium 260.

In example embodiments, the external device IF 211 may be selected from a universal serial bus (USB) protocol, a multimedia card (MMC) protocol, a peripheral component interconnection (PCI) protocol, a PCI-express (PCI-e or PCIe) protocol, an advanced technology attachment (ATA) protocol, a serial-ATA (SATA) protocol, a parallel-ATA (PATA) protocol, a small computer system interface (SCSI) protocol, an enhanced small disk interface (ESDI) protocol, Integrated Drive Electronics (IDE) protocol, private protocol, System Management Bus (SMBus) protocol, Inter-Integrated Circuit (I2C) protocol, Improved Inter-Integrated Circuit (I3C) protocol, and the like. The external device IF 211 may communicate with an external device 100 based on an interface using at least one of the various interface protocols.

The external device IF 211 may store write data provided from the external device 100 in the buffer memory device 220 under control of the processor 215. The external device IF 211 may provide the write data read from the storage medium 260 and stored in the buffer memory device 220 to the external device 100.

The storage medium IF 213 may provide a communication channel for sending and receiving signals between the memory controller 210 and the storage medium 260. The storage medium IF 213 may write data temporarily stored in the buffer memory device 220 to the storage medium 260 under control of the processor 215. The storage medium IF 213 may, under the control of the processor 215, transmit the read data from the storage medium 260 to the buffer memory device 220 for temporary storage.

The processor 215 may be configured to be operated by performing firmware or software provided on the hardware for various operations of the memory controller 210. The processor 215 may be implemented as a combination of hardware and firmware or software operating on the hardware. In an example embodiment, the processor 215 may perform functions of the flash translation layer (FTL) for managing the storage medium 260, such as block management, garbage collection, wear-leveling, and the like.

The map management circuit 217 may manage map data representing mapping relationships between logical and physical addresses. The map data may include P2L segments, which are sets of physical-to-logical address (P2L) entries, and L2P segments, which are sets of logical-to-physical address (L2P) entries.

The working memory 219 may store firmware driven by the processor 215 and metadata necessary to drive the firmware. The metadata may include at least one P2L segment and at least one L2P segment. The P2L entries may be generated after the completion of a previous map update operation until the triggering of the current map update event. To store the P2L segments, a portion of the working memory 219 may be allocated as P2L segment storage. The memory controller 210 may load and reference at least a portion of the map data stored on the storage medium 260, such as the at least one L2P segment, as metadata into the working memory 219 to process requests from the external device 100.

The buffer manager 221 may control the buffer memory device 220, such as allocating or releasing storage areas including the buffer memory device 220 in response to control from the memory controller 210.

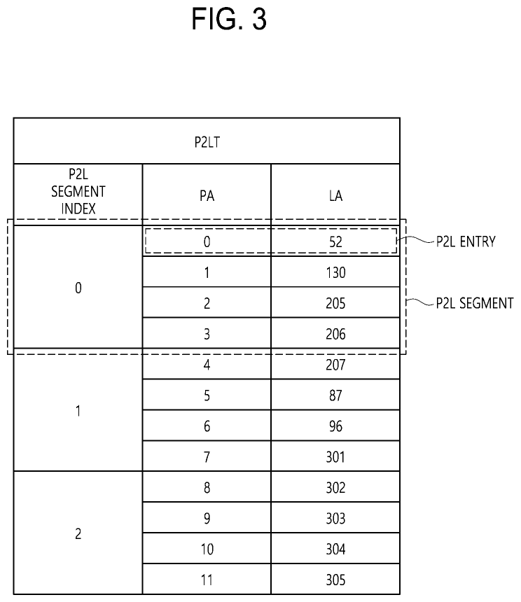

FIG. 3 is a diagram illustrating a physical-logical address table (P2LT) in accordance with example embodiments.

Referring to FIG. 3, the physical-logical address table P2LT may be built based on a physical address PA, i.e., the P2LT may be sorted by the physical address PA. The P2LT may include logical address LA information corresponding to the physical address PA as an index.

A pair of a physical address PA and a corresponding logical address LA may constitute a P2L entry. For example, as illustrated in FIG. 3, the physical address 0 and the logical address 52 may constitute a P2L entry. Multiple P2L entries may constitute a P2L segment (for example, as shown in FIG. 3, for physical addresses 0 to 3 and their corresponding logical addresses 52, 130, 205 and 206), and P2L segments may be indexed (for example, illustrated as P2L segments 0 to 2).

The P2L entries included in a P2L segment may be created from the time the previous map update operation was completed until the current map update event is triggered.

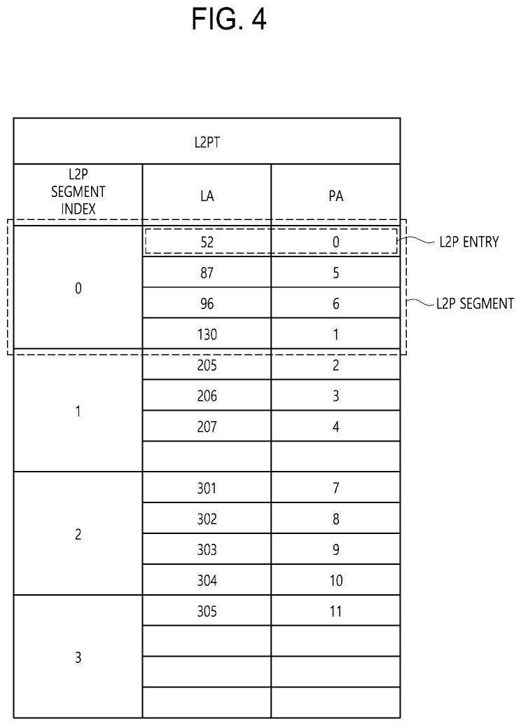

FIG. 4 is a diagram illustrating a logical-to-physical address table (L2PT) in accordance with an embodiment of the present disclosure.

FIG. 4 may be updated based on the P2LT shown in FIG. 3 and may be inversely related to the P2LT of FIG. 3.

The logical-to-physical address table L2PT may be updated based on P2L segments and may be built based on logical addresses LA, i.e., the L2PT may be sorted based on logical addresses LA. The L2PT may include physical address PA information corresponding to the logical address LA as an index.

A pair of a physical address LA and a corresponding physical address PA may constitute an L2P entry. For example, as illustrated in FIG. 4, the logical address 52 and the physical address 0 may constitute an L2P entry. Multiple L2P entries may constitute an L2P segment (for example, as shown in FIG. 4, for logical addresses 52, 87, 97 and 130 and their corresponding physical addresses 0, 5, 6 and 1), and an L2P segment may be indexed (for example, illustrated as L2P segments 0 to 2).

Referring again to FIG. 2, the map management circuit 217 may include a search circuit 301 and an update circuit 303.

The search circuit 301 may be configured to search for at least one L2P entry to be updated when a map update event may be triggered and store the L2P entry in turn in the map update buffer (MUB) of the update circuit 303.

Specifically, the search circuit 301 may read an L2P segment to be updated among the L2PTs stored in the storage medium 260 based on the updated P2L segment. The search circuit 301 may store at least one L2P entry to be updated in the read L2P segment in turn in the map update buffer (MUB).

In accordance with embodiments of the present disclosure, the map update event may be triggered when the P2L segment storage of the working memory 219 is fully stored, when a set number of P2L entries is stored in the P2L segment storage, when the memory area where the write operation is performed is full, or at a set time interval.

The update circuit 303 may allocate a portion of the internal memory as a map update buffer (MUB) when a map update event is triggered. The update circuit 303 may be configured to update the L2P entries to be updated in the map update buffer (MUB) in the order in which the L2P entries may be stored. The update circuit 303 may reference the updated P2L segments to update the L2P entries.

Once all of the L2P entries in the L2P segment to be updated have been updated, the update circuit 303 may store the updated L2P segment in the L2PT on the storage medium 260 to update the L2PT to the latest state.

As such, while the first L2P entry to be updated in the L2P segment to be updated is being updated in the update circuit 303, the search circuit 301 may search for the second L2P entry to be updated in the L2P segment to be updated and store the second L2P in the map update buffer (MUB).

Thus, at least a portion of the operation in which the first entry is updated in the update circuit 303 may overlap with at least a portion of the operation in which the search circuit 301 searches for a second entry and store the second entry in the map update buffer (MUB).

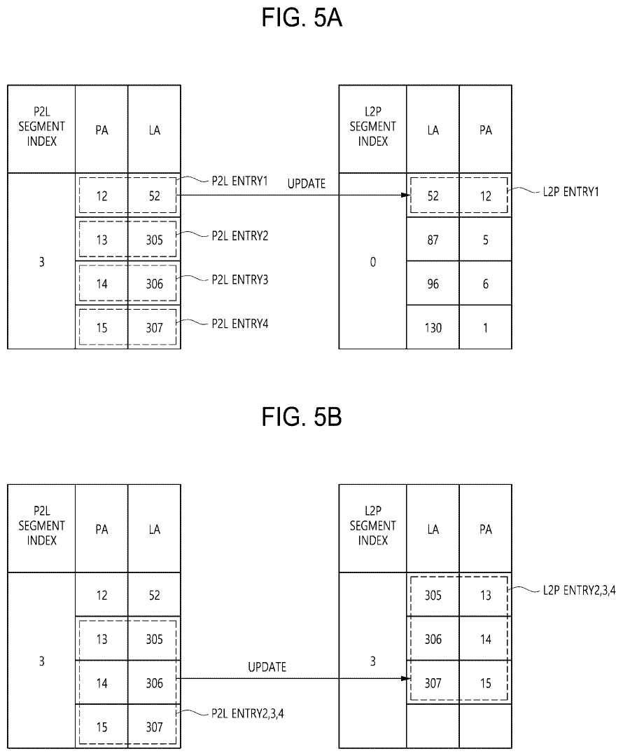

FIGS. 5A and 5B are views illustrating a concept for updating a logical-physical address table in accordance with example embodiments.

Referring to FIGS. 5A and 5B, a first entry P2L ENTRY1, a second entry P2L ENTRY2, a third entry P2L ENTRY3, and a fourth entry P2L ENTRY4 of the P2L segment of index 3 may be updated.

As the map update event may be triggered, the search circuit 301 may read the L2P segment to be updated from the storage medium 260 based on the P2L segment (index 3).

The logical addresses LA included in the P2L segment (index 3) may be 52, 305, 306, and 307. The search circuit 301 may read the L2P segment containing logical addresses LA 52, 305, 306 307 during the L2PT.

For example, the logical address LA 52 may be included in the L2P segment at index 0, and the logical addresses LA 305, 306, and 307 may be included in the L2P segment at index 3.

Referring to FIG. 5A, the search circuit 301 may search for and read an L2P segment (index 0) containing the logical address LA 52 from the L2PT of the storage medium 260. The search circuit 301 may search for an entry L2P ENTRY1 corresponding to the logical address LA 52 in the read L2P segment (index 0) and store the entry L2P ENTRY1 in the map update buffer (MUB).

As the first entry L2P ENTRY1 to be updated may be stored in the map update buffer MUB, the update circuit 303 may update the mapping information of the first entry L2P ENTRY1 to be updated by referring to the first entry P2L ENTRY1 of the P2L segment (index 3).

Since all entries in the L2P segment (index 0) may be updated, the update circuit 303 may store the L2P segment (index 0) in the L2PT of the storage medium 260.

Referring to FIG. 5B, the search circuit 301 may search for and read an L2P segment (index 3) containing logical addresses LAs 305, 306, and 307 from the L2PT of the storage medium 260. The search circuit 301 may search for a second entry L2P ENTRY2 corresponding to logical address LA 305 in the read L2P segment (index 3) and store the second entry L2P ENTRY2 in the map update buffer (MUB).

As the second entry L2P ENTRY2 to be updated may be stored in the map update buffer MUB, the update circuit 303 may update the mapping information of the second entry L2P ENTRY2 to be updated by referring to the second entry P2L ENTRY2 of the P2L segment (index 3).

While the second entry to be updated L2P ENTRY2 is (being) updated in the update circuit 303, the search circuit 301 may search for the third entry to be updated L2P ENTRY3 in the L2P segment (index 3) and store the third entry in the map update buffer (MUB).

After completing the update of the second entry to be updated L2P ENTRY2, the update circuit 303 may update the third entry to be updated (L2P ENTRY3) stored in the map update buffer (MUB) by referencing the third entry of the P2L segment (index 3).

While the third entry to be updated L2P ENTRY3 is (being) updated in the update circuit 303, the search circuit 301 may search for the fourth entry to be updated L2P ENTRY4 in the L2P segment (index 3) and store the fourth entry in the map update buffer (MUB).

After completing the update of the third entry to be updated L2P ENTRY3, the update circuit 303 may update the fourth entry to be updated L2P ENTRY4 stored in the map update buffer (MUB) by referencing the fourth entry of the P2L segment (index 3).

Since all entries in the L2P segment (index 3) may be updated, the update circuit 303 may store the L2P segment (index 3) in the L2PT of the storage medium 260.

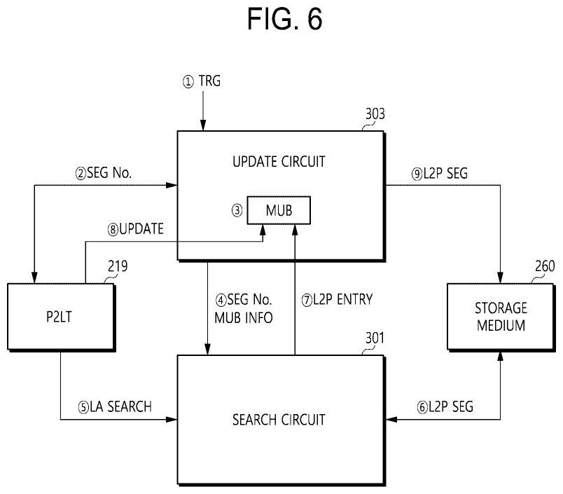

FIG. 6 is a diagram illustrating a method of operating a data storage device in accordance with example embodiments.

Referring to FIG. 6, when a map update event may be triggered (TRG) (\textcircled{1}), the update circuit 303 may refer to the P2LT stored in the working memory 219 to extract an updated P2L segment number (SEG No.) (\textcircled{2}). The update circuit 303 may then allocate a portion of the internal memory as a map update buffer (MUB) (\textcircled{3}). The map update buffer (MUB) may be part of a tightly coupled memory TCM provided in the update circuit 303. The update circuit 303 may transmit the extracted P2L segment number (SEG No.) and the address information MUB INFO of the map update buffer (MUB) (\textcircled{4}).

The search circuit 301 may search for the logical address LA to be updated from the P2LT based on the P2L segment number (SEG No.) (\textcircled{5}). The search circuit 301 may search for the L2P segment L2P SEG containing the logical address LA to be updated from the storage medium 260 and read the L2P Segment (\textcircled{6}). Based on the Read L2P Segment L2P Seg and the Updated P2L segment, the search circuit 301 may search for the L2P entry to be updated and store the L2P entry in the map update buffer (MUB) of the update circuit 303 (\textcircled{7}).

The update circuit 303 may update the L2P entry by searching for the physical address of the updated P2L segment according to the logical address LA of the L2P entry stored in the map update buffer MUB (\textcircled{8}).

Once the updates to all update target L2P entries in the read L2P segment L2P SEG may be completed, the update circuit 303 may store the updated L2P segment L2P SEG in the storage medium 260 to update the L2PT to the latest state (\textcircled{9}).

The L2P segment to be updated may include a plurality of L2P entries to be updated. The search circuit 301 may search for the L2P entries to be updated in the L2P segment to be updated in turn and store the L2P entries in the map update buffer (MUB). While the update circuit 303 may update the L2P entries stored in the map update buffer MUB, the search circuit 301 may search for the next L2P entry to be updated in the L2P segment to be updated and store the next L2P entry in the map update buffer MUB.

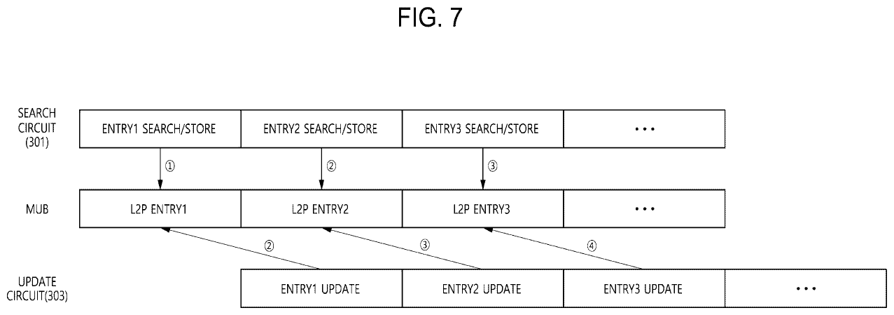

FIG. 7 is a diagram illustrating a concept for searching for and updating logical-physical address entries in accordance with an embodiment of the present disclosure.

Referring to FIG. 7, the search circuit 301 may search for a first L2P entry to be updated in the L2P segment to be updated and store the first L2P in the map update buffer (MUB) (\textcircled{1}) (for example, L2P ENTRY1).

The update circuit 303 may update the first L2P entry stored in the map update buffer (MUB) (\textcircled{2}). While the first L2P entry may be updated, the search circuit 301 may search for a second L2P entry to be updated in the L2P segment to be updated and store the second L2P entry in the map update buffer (MUB) (\textcircled{2}) (for example, L2P ENTRY2).

The update circuit 303 may update the second L2P entry stored in the map update buffer (MUB) (\textcircled{3}). While the second L2P entry may be updated, the search circuit 301 may search for a third L2P entry to be updated in the L2P segment to be updated and store the third L2P entry in the map update buffer MUB (\textcircled{3}) (for example, L2P ENTRY3).

The update circuit 303 may update the third L2P entry stored in the map update buffer (MUB) (\textcircled{4}).

Although not shown, while the third L2P entry may be updated, the search circuit 301 may search for a fourth L2P entry to be updated in the L2P segment to be updated and store the fourth L2P entry in the map update buffer (MUB).

As such, while the update circuit 303 may update the first L2P entry to be updated, the search circuit 301 may search for the second L2P entry to be updated and store the second L2P entry in the map update buffer (MUB). At least a portion of the operation where the first entry may be updated and at least a portion of the operation where the second entry may be searched and stored in the map update buffer (MUB) may overlap to improve map update performance.

In particular, when processing random write requests from external devices 100, the mapping information for non-contiguous logical addresses may be changed at high speed.

Those skilled in the art to which the present invention belongs will understand that the invention may be practiced in other specific forms without altering its technical idea or essential features. It should therefore be understood that the embodiments described above are exemplary in all respects and are not intended to be limiting. The scope of the invention is indicated by the following patent claims rather than by the detailed description above, and all modifications or variations derived from the meaning and scope of the claims and their equivalents are to be construed as being within the scope of the invention.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and one or more processors of any type of digital computer. Generally, a processor will receive instructions and data from a read only memory or a random-access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices. The processor and the memory can be supplemented by, or incorporated in, special purpose logic circuitry.

While present disclosure contains many specifics, these should not be construed as limitations on the scope of any invention or of what may be claimed, but rather as descriptions of features that may be specific to particular embodiments of particular inventions. Certain features that are described in the present disclosure in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations, one or more features from a combination can in some cases be excised from the combination, and the combination may be directed to a sub-combination or a variation of a sub-combination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the embodiments described in the present disclosure should not be understood as requiring such separation in all embodiments.

What is claimed is:

1. A data storage device comprising:
a storage medium; and
a memory controller configured to control the storage medium, wherein the memory controller is configured to:
create a physical-logical address table (P2LT) with mapping information between a physical address of the storage medium and a logical address provided from an external device,
read an update target logical-physical address (L2P) segment from a logical-physical address table (L2PT) stored on the storage medium based on the P2LT,
store an update target L2P entry from the update target L2P segment in a map update buffer, and update the physical address of the update target L2P entry whenever the update target L2P entry is stored in the map update buffer.

2. The data storage device of claim 1, wherein the memory controller comprises:
a search circuit configured to store L2P entries to be updated in turn in the map update buffer as the update target L2P entry; and
an update circuit, including the map update buffer, configured to update the physical address of the update target L2P entry.

3. The data storage device of claim 2, wherein the update circuit allocates at least a portion of memory in the update circuit to the map update buffer.

4. The data storage device of claim 1, wherein the memory controller is configured to store the L2P segment in the L2PT when all L2P entries to be updated are updated.

5. The data storage device of claim 1, wherein the memory controller is configured to store a second L2P entry of the update target L2P segment in the map update buffer while a first L2P entry of the update target L2P segment is updated.

6. The data storage device of claim 1, wherein the memory controller is configured to:
control an overlap between at least a portion of operation for updating a first L2P entry of the update target L2P segment and at least a portion of operation for searching for a second L2P entry of the update target L2P segment and storing the second L2P entry in the map update buffer.

7. A method of operating a data storage device including a storage medium and a memory controller, the method comprising:
generating, by the memory controller, mapping information between a physical address of the storage medium and a logical address provided from an external device as a physical-logical address table (P2LT);
reading, by the memory controller, an update target logical-physical address (L2P) segment from a logical-physical address table (L2PT) stored in the storage medium ;
storing, by the memory controller, an update target L2P entry from the L2P segment in a map update buffer, wherein the update target L2P entry comprises at least one L2P entry to be updated; and
updating, by the memory controller, the physical address of the update target L2P entry each time the update target L2P entry is stored in the map update buffer.

8. The method of claim 7, wherein the storing the update target L2P entry from the L2P segment in a map update buffer and the updating the physical address of the update target L2P entry are performed independently by the memory controller.

9. The method of claim 8, further comprising allocating, by the memory controller, at least a portion of memory in the memory controller to the map update buffer.

10. The method of claim 7, further comprising storing, by the memory controller, the L2P segment in the L2PT when all L2P entries to be updated are updated.

11. The method of claim 7, further comprising:
storing, by the memory controller, a second L2P entry of the update target L2P segment in the map update buffer while a first L2P entry of the update target L2P segment is updated.

12. The method of claim 7, further comprising:
controlling, by the memory controller, an overlap between at least a portion of operation for updating a first L2P entry of the update target L2P segment and at least a portion of operation that searching for a second L2P entry of the update target L2P segment and storing the second L2P entry in the map update buffer.

13. A memory controller comprising:
a search circuit, when a map update event is triggered, configured to search for at least one update target logical-to-physical address (L2P) entry from a storage medium and store the at least one update target L2P entry in a map update buffer; and
an update circuit configured to allocate a portion of an internal memory to the map update buffer when the map update event is triggered, and update the at least one update target L2P entry stored in the map update buffer on an entry-by-entry basis.

14. The memory controller of claim 13, wherein the update circuit is configured to allocate at least a portion of the memory in the update circuit to the map update buffer.

15. The memory controller of claim 13, wherein the search circuit is configured to search for and read an L2P segment to be updated from the storage medium, and search for the L2P entry to be updated from the L2P segment.

16. The memory controller of claim 15, wherein the update circuit is configured to store an updated L2P segment having all of the updated L2P entries in a logical-physical address table (L2PT) stored on the storage medium.

17. The memory controller of claim 13, wherein the search circuit is configured to store a second L2P entry to be updated in the map update buffer while the update circuit is updating a first L2P entry to be updated.

18. The memory controller of claim 15, further comprising:
a storage for storing a physical-to-logical (P2L) table corresponding to the L2P segment.

19. The memory controller of claim 18, wherein the map update event is triggered when the storage is fully stored, when a set number of P2L entries is stored in the storage, or at a set time interval.
